(19) United States
(12) Patent Application Publication
(10) Pub. No.: US 2020/0003304 A1
(43) Pub. Date: Jan. 2, 2020

(54) METHOD FOR CONTROLLING AN ACTUATOR FOR A VEHICLE, CONTROL APPLIANCE AND PARKING LOCK DEVICE FOR A VEHICLE

(71) Applicant: ZF Friedrichshafen AG, Friedrichshafen (DE)

(72) Inventor: Sascha Tränkner, Rehden (DE)

(73) Assignee: ZF Friedrichshafen AG, Friedrichshafen (DE)

(21) Appl. No.: 16/484,935

(22) PCT Filed: Jan. 15, 2018
(86) PCT No.: PCT/EP2018/050824

§ 371 Date: Aug. 9, 2019

(30) Foreign Application Priority Data
Feb. 20, 2017 (DE) 10 2017 202 647.2

(51) Int. Cl. F16H 63/48; F16H 63/34

(52) U.S. Cl. CPC F16H 63/48; F16H 63/3458

(57) ABSTRACT

The invention relates to a method for actuating an actuator (104) for a vehicle, wherein the actuator (104) is or can be coupled to a drive unit (106) for powering the actuator (104) and to a sensor (110) via a sensor gearing (108) for detecting a position and/or change in position of the sensor gearing (108). In the method, a sensor signal (114) is first input, which represents a position and/or change in position of the sensor gearing (108) detected by the sensor (110). The sensor signal (114) is used along with a gear ratio of the sensor gearing (108) in another step to determine actuator information representing a position and/or change in position of an actuator (104). Lastly, a suitable actuation signal (116) is generated on the basis of the actuator information to actuate the actuator (104).

The present invention relates to a method for controlling an actuator for a vehicle, a corresponding control device, a corresponding computer program, and a parking lock device for a vehicle.

DE 600 06 666 T2 describes a position regulator for a motor that regulates a position of the motor on the basis of a load position signal from a position sensor attached to a load powered by the motor.

Based on this, the present invention creates an improved method for actuating an actuator for a vehicle, an improved control device and an improved parking lock device for a vehicle according to the independent claims. Advantageous embodiments can be derived from the dependent claims and the following description.

A method for actuating an actuator in a vehicle is presented in which the actuator can be or is coupled to a drive unit for powering the actuator and via a sensor gearing that has a sensor for detecting a position and/or change in position of the sensor gearing, wherein the method comprises the following steps:

inputting a sensor signal representing a position and/or change in position of the sensor gearing detected by the sensor;

determining actuator information representing a position and/or change in position of the actuator based on the sensor signal and a gear ratio of the sensor gearing; and

generating an actuation signal for actuating the sensor based on the actuator information.

An actuator can be a cable pull or some other component for mechanical actuation. In particular, the actuator can be a component of a shifting transmission, e.g. an automatic transmission. The actuator can be configured to activate a parking lock in the vehicle, e.g. by engaging a specific gear in the shifting transmission, or by engaging the brakes in a vehicle. A drive unit can be an electric motor, for example. A sensor gearing can be a gearing that converts a movement of the actuator corresponding to a predefined gear ratio to a movement of a driving force that can be detected by the sensor.

The approach described herein is based on the knowledge that a sensor gearing can be used for a simple and clear detection of a position or change in position of an actuator in a vehicle, e.g. a parking lock actuator in the form of a cable pull. In particular, such a detection has the advantage that the position or change in position of the actuator can be computed directly from a position or change in position of the sensor gearing. An additional evaluation of a sensor signal curve for determining a position, for example, is therefore unnecessary.

According to one embodiment, the calculation can be made directly on the position of the actuator in the step for determining the sensor signal based on the gear ratio of the sensor gearing, in order to obtain the actuator information. As a result, it is possible to determine the position of the actuator quickly and efficiently.

According to another embodiment, a rotational rate of the drive unit can be determined on the basis of the actuator information in a determining step. Accordingly, the actuation signal can be generated in a generating step on the basis of the rotational rate. As a result, it is possible to reliably determine the rotational rate of the drive unit.

The actuator can be or is coupled to the drive unit via a drive gearing. In the generating step, the actuation signal can be generated accordingly on the basis of a gear ratio in the drive gearing. As a result, the actuator can be actuated precisely with a drive gearing.

It is also advantageous when the actuation signal is generated in the generating step, in order to set a target speed for moving the actuator to a target position. As a result, the actuator can he moved at different speeds.

According to another embodiment, an analog signal can be input as the sensor signal in the input step. As a result, the sensor signal can be readily processed.

The approach presented herein also relates to a control device configured to execute, actuate or implement the steps of any variation of the method presented herein in corresponding devices. The fundamental object of the invention can also be quickly and efficiently obtained with this embodiment variation of the invention in the form of a control device.

For this, the control device can contain at least one computing unit for processing signals or data, at least one memory for storing signals or data, at least one interface to a sensor or an actuator for inputting sensor signals from the sensor or outputting control signals to the actuator and/or at least one communication interface for inputting or outputting data embedded in a communication protocol. The computing unit can be a signal processor, a. microcontroller, etc. and the memory can be a flash drive, an EPROM, or a magnetic memory. The communication interface can be configured for wireless and/or hardwired data input or output, wherein a communication interface configured for hardwired data input or output can electrically or optically input these data from a corresponding data transfer line or output them to a corresponding data transfer line.

A control device is an electric device in the present case, that processes sensor signals and outputs control and/or data signals on the basis thereof The control device can have a hardware and/or software interface. A hardware interface can be part of a so-called system ACIS containing various functions of the control device. The interfaces can also be separate integrated circuits, or at least partially comprised of discrete components. A software interface can comprise software modules on a micro controller, in addition to other software modules.

In an advantageous embodiment, the vehicle is controlled b r the control device. The control device can access sensor signals for this, e.g. acceleration, pressure, steering angle, or environment sensors. The actuation takes place via actuators such as brake or steering actuators, or a motor control device in the vehicle.

The approach presented herein also results in a parking lock device for a vehicle, wherein the parking lock device comprises the following features:

an actuator for activating the parking lock;

a drive unit for driving the actuator;

a sensor gearing;

a sensor for detecting a position and/or change in position of the sensor gearing, wherein the actuator is coupled to the sensor via the sensor gearing; and

a control device according to any of the embodiments described above.

The parking lock device can be part of an automated shifting actuator, wherein the automated shifting actuator is configured to execute numerous functions, e.g. engaging reverse, forward, and/or neutral gears.

According to one embodiment, the actuator can be a cable pull. As a result, the actuator is very robust, while still remaining light and requiring little space.

A computer program product or computer program that contains program code that can be stored on a machine readable carrier or memory, e.g. a semiconductor memory, a hard drive, or an optical memory, and used for executing, implementing, and/or actuating the steps of the method according to any of the embodiments described above, in particular when the program product or program is executed on a computer or a device.

The invention shall be explained below in greater detail based on the attached drawings. Therein:

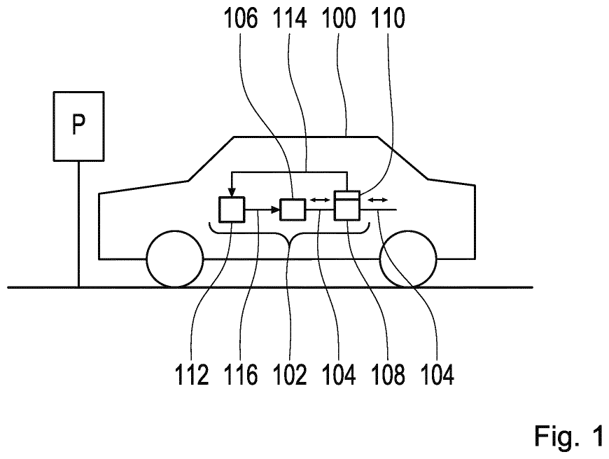

FIG. 1 shows a schematic illustration of a vehicle that has a parking lock device according to an exemplary embodiment;

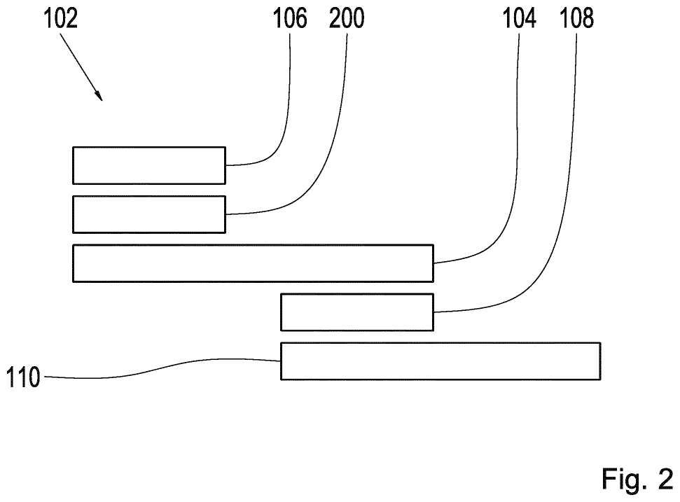

FIG. 2 shows a schematic it lustration of a parking lock device according to an exemplary embodiment;

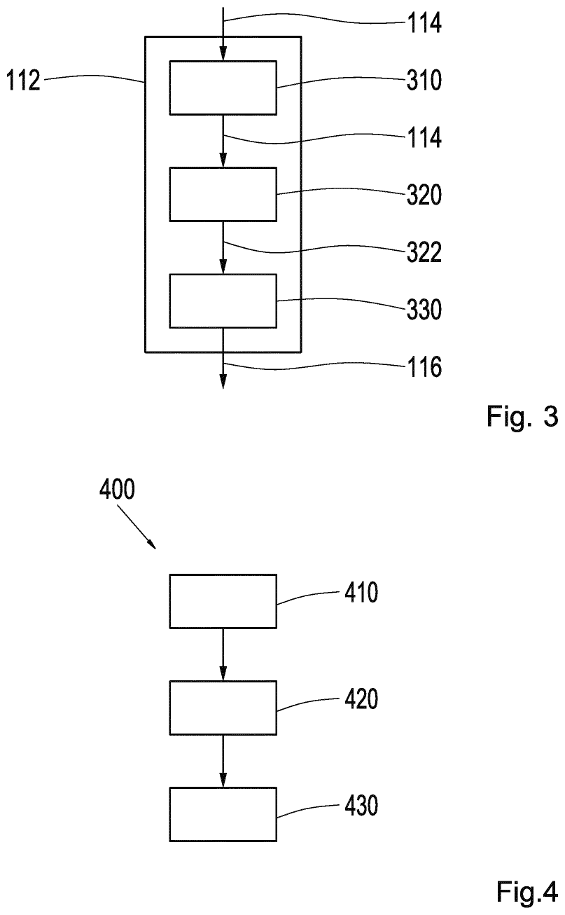

FIG. 3 shows a schematic illustration of a control device according to an exemplary embodiment; and

FIG. 4 shows a flow chart for a method according to an exemplary embodiment.

In the following description of preferred exemplary embodiments of the present invention, the same or similar reference symbols are used for the elements shown in the various figures with similar functions, wherein there shall be no repetition of the descriptions thereof.

FIG. 1 shows a schematic illustration of a vehicle 100 with a parking lock device 102 according to an exemplary embodiment. The parking lock device 100 comprises an actuator 104 for activating a parking lock in the vehicle 100, by means of which a rolling away of the parked vehicle 100 can be prevented, as indicated by way of example in FIG. 1. According to the exemplary embodiment shown in FIG. 1, the actuator 104 is formed by a cable pull for a mechanical actuation of a shifting transmission, in particular an automatic transmission, or a brake system in the vehicle 100. Alternatively, the actuator 104 can also be formed by a lever or a toothed rack. The actuator 104 is coupled to a suitable drive unit 106 in the form of a servomotor, for adjusting the position of the actuator 104. The actuator 104 is also coupled to a sensor gearing 108, and the sensor gearing 108 contains a sensor 110 for detecting a position or change in position of the sensor gearing 108. Both the sensor 110 and the drive unit 106 are connected to a control device 112 for controlling the drive unit 106.

The control device 112 is configured to input a sensor signal 114 representing the position or change in position of the sensor gearing 108, and to evaluate this signal to determine a position or change in position of the sensor gearing 108, taking a predefined gear ratio of the sensor gearing 108 into account. Depending on the result of this evaluation, the control device 112 generates a suitable actuation signal 116 for actuating the drive unit 106 based on the position or change in position of the actuator 104 determined with the sensor gearing 108. Advantageously, the position or change in position of the actuator 104 can be determined directly by the control device 112 from the position or change in position of the sensor gearing 108 recorded by the sensor 110 based on the known gear ratio of the sensor gearing 108.

By detecting the actuator position and regulating the actuator gearing via the sensor gearing 108, a basic function, by means of which the actuator 104 is positioned and moved, can be implemented with little technological effort. In particular, the use of the sensor gearing 108 enables a simple implementation of a method for one-to-one positioning of a cable pull in a vehicle 100, and for regulating the speed of the change in position of the cable pull using the sensor 110.

FIG. 2 shows a schematic illustration of a parking lock device 102 according to an exemplary embodiment. The parking lock device 102 corresponds substantially to the parking lock device described above in reference to FIG. 1, with the difference that the drive unit 106 according to this exemplary embodiment is mechanically coupled to the actuator 104 via an optional drive gearing 200. Accordingly, the drive unit 106 is also controlled taking a predefined gear ratio of the drive gearing 200 into account, as shall be described in greater detail below.

An overall working range of the actuator 104 is depicted in the measuring range of the sensor 110 by the sensor gearing 108, by way of example. As a result, the explicit position of the actuator 104 can be calculated. The rotational rate of the drive unit 106 can be regulated by the sensor signal curve over time, based on the known gear ratio of the sensor gearing 108 and the drive gearing 200. As a result, two functions can be implemented with the sensor 110.

The sensor gearing 108 is configured such that the measurement precision is increased. As a result, the explicit allocation is lost, and reference points are needed, e.g. when the working range of the actuator 104 corresponds to more than one sensor rotation.

The approach presented herein enables an explicit positioning of the actuator in the vehicle 100, in particular a cable pull, as well as a regulation of the speed of the change in position, using the sensor 110. According to one exemplary embodiment, an actual position x of the actuator 104 and a speed dx/dt of the actuator 104 are determined for this. The sensor 110 is moved via the sensor gearing 108 such that it is possible at any time to determine an explicit position of the actuator 104 based on a measurement signal y, also referred to as the sensor signal above. A measurement range Y of the sensor 110 contains the entire range of positions X of the actuator 104. It is therefore not necessary to evaluate a sensor signal curve of the sensor 110 to determine the actual position x of the actuator 104. Instead, the measurement signal y is converted directly to the actual position x based on the gear ratio of the sensor gearing 108. A rotational rate of the drive unit 106 is determined directly from the change in position of the sensor 110 over time (dy/dt). The speed dx/dt of the actuator is thus regulated on the basis of the gear ratio of the drive gearing 200. The measurement signal y is an analog signal, by way of example.

The actuation of a cable pull comprises the following steps, by way of example:

in a first step, the position of the cable pull, also referred to as the actual position above, is detected on the basis of the measurement signal y, i.e. on the basis of an actual position of the sensor, and the sensor gearing gear ratio.

In a second step, a target speed dx/dt of the cable pull is controlled on the basis of the sensor signal change dy/dt and the sensor and drive gearing gear ratios.

In a third step, the cable pull is positioned in the position range X, and the position is permanently monitored or corrected on the basis of the measurement signal y.

FIG. 3 shows a schematic illustration of a control device 112 according to an exemplary embodiment, such as the control device described above in reference to FIG. 1. The control device 112 comprises an input unit 310 for inputting the sensor signal 114, wherein the input unit 310 is connected to a detection unit 320 for determining actuator information 322 representing a position or change in position of the actuator based on the sensor signal 114 and the gear ratio of the sensor gearing. The detection unit 320 conveys the actuator information 322 to a generating unit 330, which is configured to generate the actuation signal 116 for actuating the drive unit based on the actuator information 322.

FIG. 4 shows a flow chart for a method 400 according to an exemplary embodiment. The method 400 for actuating an actuator for a vehicle can be executed using a control device, such as that described above in reference to FIGS. 1 to 3. The sensor signal from the sensor in the sensor gearing is input in step 410, and used in combination with the known gear ratio of the sensor gearing in step 420 for determining the actuator information. The actuation signal for actuating the drive unit is generated in step 430 based on the actuator information.

If an exemplary embodiment comprises an “and/or” conjunction between a first feature and a second feature, this can be read to mean that the exemplary embodiment according to one embodiment contains both the first feature and the second feature, and according to another embodiment, contains either just the first feature, or just the second feature.

### REFERENCE SYMBOLS

100 vehicle

102 parking lock device

104 actuator

106 drive unit

108 sensor gearing

110 sensor

112 control device

114 sensor signal

116 actuation signal

200 drive gearing

310 input unit

320 detection unit

322 actuator information

330 generating unit

400 method for actuating an actuator in a vehicle

410 input step

420 determination step

430 generating step

1. A method for actuating an actuator for a vehicle, wherein the actuator is coupled to a drive unit for powering the actuator and via a sensor gearing to a sensor for detecting a position and/or change in position of the sensor gearing, wherein the method comprises the following steps:
inputting a sensor signal that represents a position and/or change in position of the sensor gearing detected by the sensor;
determining actuator information representing a position and/or change in position of the actuator based on the sensor signal and a gear ratio of the sensor gearing; and
generating an actuation signal for actuating the actuator based on the actuator information.

2. The method according to claim 1, wherein the sensor signal is converted directly to the position of the actuator in the determining step based on the gear ratio of the sensor gearing, in order to obtain the actuator information.

3. The method according to claim 1, further comprising a step for determining a rotational rate of the drive unit based on the actuator information, wherein the actuation signal is generated in the generating step based on the rotational rate.

4. The method according to claim 1, wherein the actuator is coupled to the drive unit via a drive gearing, wherein the actuation signal is generated in the generating step based on a gear ratio of the drive gearing.

5. The method according to claim 1, wherein the actuation signal is generated in the generating step, in order to set a target speed for moving the actuator to a target position.

6. The method according to claim 1, wherein an analog signal is input as the sensor signal in the input step.

7. A control device that has units configured to execute and/or actuate the method according to claim 1.

8. A parking lock device for a vehicle, wherein the parking lock device comprises:
an actuator for activating the parking lock;
a drive unit for powering the actuator;
a sensor gearing;
a sensor for detecting a position and/or change in position of the sensor gearing, wherein the actuator is coupled to the sensor via the sensor gearing; and
a control device according to claim 7.

9. The parking lock device according to claim 8, wherein the actuator is formed by a cable pull.

10. A computer program that is configured to execute and/or actuate the method according to claim 1.

11. A machine readable memory on which the computer program according to claim 10 is stored.
